(19) United States
(12) Patent Application Publication
(10) Pub. No.: US 2009/0109113 A1
(43) Pub. Date: Apr. 30, 2009

(54) RADIO FREQUENCY ACCESSORY FOR AN ELECTRONIC PORTABLE DEVICE AND SYSTEM THEREOF

(75) Inventor: Henri CROHAS, Verrieres-Le-Buisson (FR)

Correspondence Address: YOUNG & THOMPSON, 209 Madison Street, Suite 500, ALEXANDRIA, VA, 22314, US

(73) Assignee: ARCHOS S.A., Igny (FR)

(21) Appl. No.: 12/262,043

(22) Filed: Oct. 30, 2008

(30) Foreign Application Priority Data
Oct. 31, 2007 (FR) 07/07684

(51) Int. Cl. H01Q 1/08; H01Q 7/08

(52) U.S. Cl. 343/788; 343/880

(57) ABSTRACT

An accessory comprising at least two antennas for receiving and/or transmitting radio signals on a portable electronic appliance with the help of compact and self-contained means suitable for use while mobile.

### FIELD

An accessory for digital portable electronic appliances having hardware and software resources for displaying an image and executing at least one application, such as, for example: a portable multimedia player (PMP); a smart phone; a personal digital assistant (PDA); a laptop computer; . . .

### Problem

Enabling a portable electronic appliance to receive and/or transmit radio signals with the help of means that are compact and self-contained and that can be used while mobile.

### Solutions in the State of the Art

Computer peripheral accessories are known that are in the form of a USB “stick” and that enable television to be received by a laptop computer.

Antenna diversity techniques are known that enable radio signal reception to be improved in the context of wireless digital transmission.

The accessories provided for digital TV reception in the state of the art are fitted with a connector that enables the accessory to be connected to an external signal source. That might be a connection to a collective antenna installation or to one or two remotely-located individual antennas.

In general, having antennas located remotely offers numerous advantages, such as simplifying the mechanical design of the accessory and greater universality for the shape of the accessory relative to the shape of the appliance to which it is connected. In addition, keeping antennas separate from the electronic appliance is favorable for reception, in that antennas that can be positioned freely make it easier to find a position in which the signal is picked up better. It is also favorable for the antennas to be spaced apart from the portable electronic appliance and/or the accessory device of the invention in that electronic subassemblies generally constitute sources of noise. That said, such an installation is not suitable for mobile use.

### SOLUTION OF THE INVENTION

Prior art solutions provide a partial and unsatisfactory response to the problem of receiving and/or transmitting radio signals with the help of compact and self-contained means suitable for use while mobile.

The device of the invention enables a portable electronic appliance to receive and/or transmit radio signals. The device comprises at least one electronic subassembly, means for connecting the at least one electronic subassembly of the device to the electronic appliance, at least two non-removable antennas used in diversity mode that are secured to the device by implementing means that conserve the relative positions between said antennas and the device in the absence of external forces being applied between said elements.

The device may be an accessory that is dedicated to one type or model of portable electronic appliance, or it may be a universal accessory that can be used as a periphery with a variety of electronic appliances.

The term “at least one electronic subassembly” should be understood as meaning one or more functional units capable of being implemented in the form of one or more printed circuits. For example, this may involve performing all or some of the functions in the following non-limiting list, possibly in a different order: amplifying the signal coming from the antennas; combining signals; demodulation; managing diversity; decoding; and managing the interface with the portable appliance.

The term “at least two antennas used in diversity mode” should be understood as implementing at least one diversity technique seeking to increase the performance of a wireless digital transmission system. By way of example, the increase in performance provided by the antenna diversity is particularly advantageous for receiving digital radio and/or TV under good conditions while mobile. This applies in particular if the antenna diversity is associated with a dedicated reception channel per antenna and suitable signal processing. When the portable electronic appliance is to be given connectivity with networks by means of the device of the invention, the antenna diversity may also be operated in transmission, e.g. in the context of MIMO type solutions such as those implemented in the IEEE 802.lln standard. Antenna diversity can involve an unlimited number of antennas, and it is merely constraints of cost, size, and/or appearance that limits this number, usually to two or three antennas only. Implementation of the invention may involve no more than diversity in terms of the locations of identical antennas, however it may also involve polarization diversity, antenna type diversity, and more generally it may involve implementing any technique that makes it possible to increase the probability at any given instant of at least one antenna being in satisfactory operating conditions. Nevertheless, it remains within the ambit of the invention to implement so-called microdiversity techniques, i.e. when the distance between the antennas is of the same order as the wavelength used.

In certain embodiments of the invention, provision is made for the device further to comprise at least one separable rigid mechanical connection for fastening the device to the portable electronic appliance.

The at least one separable rigid mechanical connection may advantageously include contacts for connecting the at least one electronic subassembly of the device to the portable electronic appliance to which it is fastened. This may be provided, for example, by a specific connector or indeed by a standard connector that is sufficiently robust, for example a type A USB connector.

Provision is made for the connection between the device and the antenna to take place via a separable rigid mechanical connection that includes contacts in addition to at least one other separable rigid mechanical connection that does not include contacts and that serves to reinforce the mechanical robustness of the assembly.

Provision is also made for the connection between the device and the appliance to make use of wired means, such as at least one cable fitted with at least one connector, or indeed wireless means, e.g. using the ad hoc WiFi, WUSB, or Bluetooth standards.

The term “at least two non-removable antennas secured to the device by implementing means that conserve the relative positions between said antennas and the device in the absence of external forces being applied between said elements” should be understood as meaning that in the device of the invention the antennas are fastened to the body of the device by making use of techniques that are not suitable for being taken apart. When at least one degree of freedom is available, then provision is made for friction forces to conserve the positions of the elements relative to one another so long as no other force of greater magnitude is applied. The purpose is to ensure that when any change in the positioning of an element of the system relative to the others is possible, it should be conserved so long as no other action countermands it. This purpose may be achieved, for example, by connecting together the elements of the system of the invention by means that are rigid, semirigid, or flexible so as to conserve relative positions from a given position. Degrees of freedom may advantageously be incorporated in the assemblies, both to facilitate storage of the accessory and to enable adjustments of orientation to be optimized.

In addition, the use of flexible and/or hinge elements reduces the fragility of the accessory, and/or of the system it constitutes with the electronic appliance to which it is connected. Systems made up of deformable elements are less fragile in that they can be subjected to the effects of external forces without irreversible damage.

The device of the invention also provides for at least one non-removable antenna of the device to be arranged to improve its performance by the presence of a nearby ground plane and/or conductor element connected to ground. The term “ground plane” is used to designate any solid or perforated conductive surface, optionally connected to a determined potential such as the ground of the associated reception and/or transmission electronics. Depending on the context in which it is implemented, a ground plane of the invention may for example act as the other half-dipole when using a so-called half-dipole or “whip” antenna, as a reflector (for a “quad” antenna), as a support for a dielectric (for a “patch” antenna), or as shielding against undesirable radiation.

The invention also makes provision for said ground plane and/or said conductor element to be deployable. The ground plane and/or the conductor element may be deployed as a result of deploying an antenna. It is also possible for deployment of the ground plane and/or the conductor element to be handled in a manner that is completely or partially separate from deploying the antenna, without thereby going beyond the ambit of the invention.

In a first embodiment of the invention, at least one non-removable antenna of the device is of the monopole or dipole wire type, e.g. a whip operating as a quarter-wave or a half-wave antenna.

In a second embodiment, at least one non-removable antenna of the device is of the magnetic loop type.

In a third embodiment, at least one non-removable antenna of the device is of the plane type.

In each of these three embodiments of the device, at least one other antenna may be of the same type or of a different type.

The term “plane antenna” is used to mean an antenna constituted by a plurality of individual surface area elements that are arranged in air or on a suitable solid dielectric in a common plane in order to form a composite antenna, e.g. a so-called “quad” antenna or indeed a so-called “patch” antenna. These antennas also require respectively a metal reflector or a ground plane.

In all of the above-mentioned types of antenna, the wire elements or surface area elements can be implemented using shapes that are simple, or shapes that are complex such as so-called space-filler techniques, without thereby going beyond the ambit of the invention. So-called space-filler techniques such as those relying on fractal mathematics and made available by the supplier Fractus SA, make it possible, other things being equal, and in particular wavelength being equal, to obtain dimensions that are more compact than when using traditional shapes.

In a preferred embodiment of the invention, at least one non-removable antenna of the device is deployable.

The term “deployable” is used to designate any technique making it possible to distinguish between a state of the system of the invention that is more compact for transport or storage and a utilization state that takes up more space. For example, this may involve techniques based on elements that are foldable and/or telescopic and/or suitable for rolling up, or indeed any combination of such techniques. Deployment may make use of any type of relative movement between the elements making up the antenna and/or between the antenna as a whole and the body of the accessory of the invention. These movements may be in translation and/or rotation or in any combination of these elementary types of movement.

It is possible for each antenna to make use of different deployment techniques.

In this preferred variant of the invention, the device has a plurality of deployable antennas so as to make it more compact in the storage position, so as to give it the ability to adapt to the dimensions of the portable electronic appliance to which it is fastened so as to form a one-piece assembly, and/or so as to give it the ability to orient the antennas so as to optimize operation when the portable electronic appliance is in a given orientation.

It is possible for at least one antenna out of at least two to be stationary relative to the body of the accessory of the invention. The shorter the wavelengths being used, the smaller is the need to make the antennas deployable, since they are small in size. All or some of the antennas may even be incorporated within the body of the device without thereby going beyond the ambit of the invention.

It is known that the performance of stationary antennas is improved when the radiating portion thereof is situated at a location relative to a ground plane or a metal element optionally connected to ground, depending on the technical options implemented. Deployable antennas in the state of the art do not make use of this possibility for improving their performance.

The invention provides for at least one non-removable and deployable antenna to have its performance, e.g. its gain, improved by the presence of a nearby ground plane and/or of a conductor element connected to ground. In a preferred embodiment, at least one non-removable and deployable antenna comprises both a radiating portion and a portion connected to ground.

Advantageously, the portion of the at least one non-removable and deployable antenna of the device that is connected to ground potential is situated between the radiating portion of the antenna and its attachment point situated on the body of the device.

Provision is also made for the portion that is connected to ground potential of at least one non-removable and deployable antenna of the device to include conductor elements firstly to feed the radiating portion of the antenna and secondly to shield the feed line.

In an even more advantageous embodiment of the invention, the conductors for establishing electrical continuity between the deployable antenna and the reception electronics form a connection of impedance that is substantially matched when the antenna is fully deployed. It is difficult and expensive to implement a technique that enables a deployable connection to be established that is continuously matched regardless of the amplitude of its deployment. In practice, the intermediate deployment positions are of little interest and performance is generally maximized at maximum deployment, when the antennas are the farthest apart from one another and the farthest away from the sources of noise constituted by the electronic assemblies of digital appliances.

In a first embodiment relating to the power supply to the electronic subassemblies, the device of the invention is powered by the portable electronic appliance to which it is connected.

In a second embodiment, it is the device of the invention that powers the portable electronic appliance to which it is connected. This can be done by using an energy source contained in the device and/or by using an external energy source, such as a mains power supply unit for use in a building or indeed a power supply fitted with a plug suitable for connection to the cigar lighter for use in a vehicle.

The invention provides for the device further to include a support function. This may be a function of supporting the device on its own and/or of supporting the electronic appliance when the device and the appliance are assembled together by means of a rigid connection. The term “support function” is used to cover any means for placing and/or fastening the element(s) in question on a surface, in a manner that is stable and appropriate for use and/or storage thereof. For example, the support might comprise a fixed or retractable stand, a suction cup, a magnetic fastener, or fastening by clamping between jaws.

Including a support function in the device of the invention is particularly relevant when it is used as an accessory for a portable electronic appliance that is fastened on top of the device. With such an assembly, raising the appliance relative to the support plane makes any support that might be integrated in the portable appliance inoperative, e.g. legs of length that is designed for the appliance resting directly on a plane.

In another aspect of the invention, a system is provided for receiving and/or transmitting radio signals and for making use of them while mobile, the system comprising:

a reception device as defined above; and

a portable electronic appliance to which the device is connected.

In a first application of the system of the invention, it serves to receive digital television by means of an electronic appliance and an accessory including at least two non-removable antennas. The invention seeks also to make the system constituted by the portable electronic appliance and the reception accessory more compact in that the antennas are retractable or foldable, at least in part, and can be deployed depending on requirements. The term “deployed depending on requirements” is used to mean deployed so as to take account of the size of the housings of the portable appliance and of the accessory, and/or that enables satisfactory reception to be obtained under given positioning conditions. The term “use while mobile” should be understood as enabling digital TV to be received while the entire reception system of the invention is mobile because it is held, carried, or secured by appropriate means to a user who is moving. This may equally involve fastening or placing the system of the invention in a moving assembly that contains the user, such as private or public means for transport on land, in the air, or at sea. Mobility may also involve mobility of the user and of the system of the invention prior to use, followed by the system being used in a manner that is actually static. Such mobility prior to use may take place for example within premises, whether professional or domestic.

The term “reception of digital TV” is used to mean receiving digital TV signals broadcast by infrastructure means in application of standards such as, for example: DVB-T; DVB-H; T-DMB; CDMB; etc.

The term “reception of digital TV” is also used to mean reception of any signal transmitted by wireless means and compatible with the device, being suitable for conveying video to the system of the invention. This may involve, for example, receiving a video stream coming from a point having access to a local network or to a remote network using standards such as, for example: WiFi, WiMax, WUSB, or Bluetooth. This may also apply to a stream coming directly from another appliance in the context of a point-to-point or point-to-multipoint connection. Most such standards or variants thereof, e.g. a 802.11n, can take advantage of the antenna diversity characteristic of the accessory of the invention in order to improve the performance of the connection.

By way of example, the signal source may be a digital video recorder/player, a so-called “set top box” receiver/decoder, or indeed an appliance on board transport means, for example in the trunk of a car or in an equipment compartment of public transport means for storing content and/or for receiving streams coming from a primary connection such as a terrestrial or satellite digital broadcast network.

The signal received and made use of by the accessory of the invention may be associated with a single channel or with a plurality of channels subdivided in packets or multiplexed in time division or frequency division without going beyond the ambit of the invention.

Naturally, it remains within the ambit of the invention if only the digital audio stream is processed in an application of the invention restricted solely to receiving and/or transmitting sound.

In a second application of the system of the invention, it is possible to receive geolocation information by means of an electronic appliance and an accessory having at least two non-removable antennas. The application of the system of the invention to this context enables a quality of service to be obtained that is greater than that made available by state of the art techniques. Increased quality of service leads to greater availability of the service in contexts where state of the art techniques are no longer functional and/or leads to an increase in the accuracy of the information delivered.

The system of the invention is suitable for pedestrian use and/or for use on board a vehicle.

In a third application of the system of the invention, it is possible to connect a portable electronic appliance to a local and/or infrastructure network by means of an electronic appliance and an accessory having at least two non-removable antennas.

Other advantages and characteristics of the invention appear on examining the detailed description of a non-limiting embodiment and the accompanying drawings, in which:

FIGS. 1, 2, and 3 show a first variant of the invention;

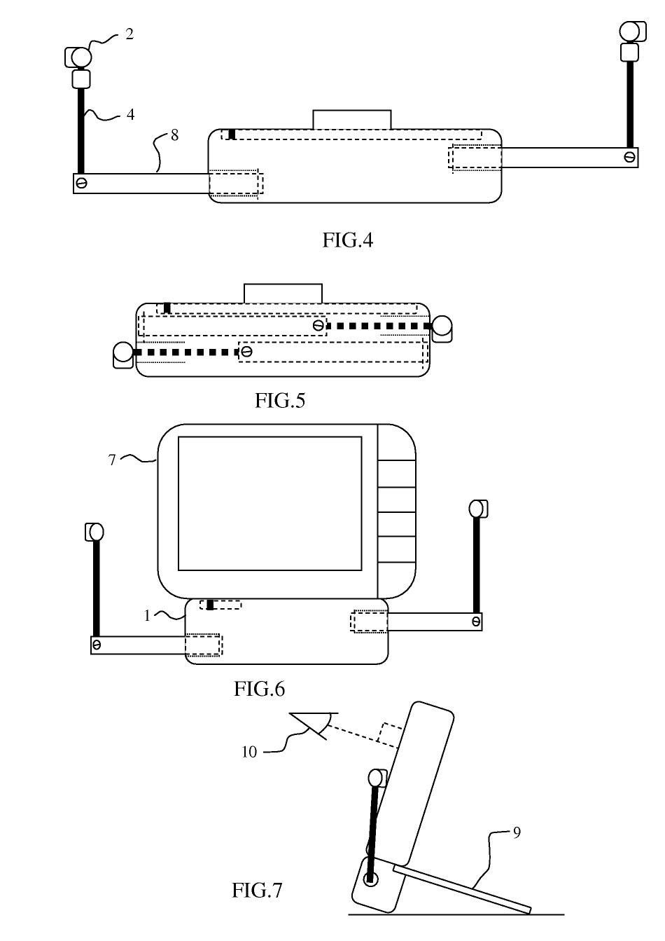

FIGS. 4, 5, 6, and 7 show a second variant of the invention;

FIGS. 8, 9, 10, and 11 show variants of the invention that differ as a function of the type of portable electronic appliance used;

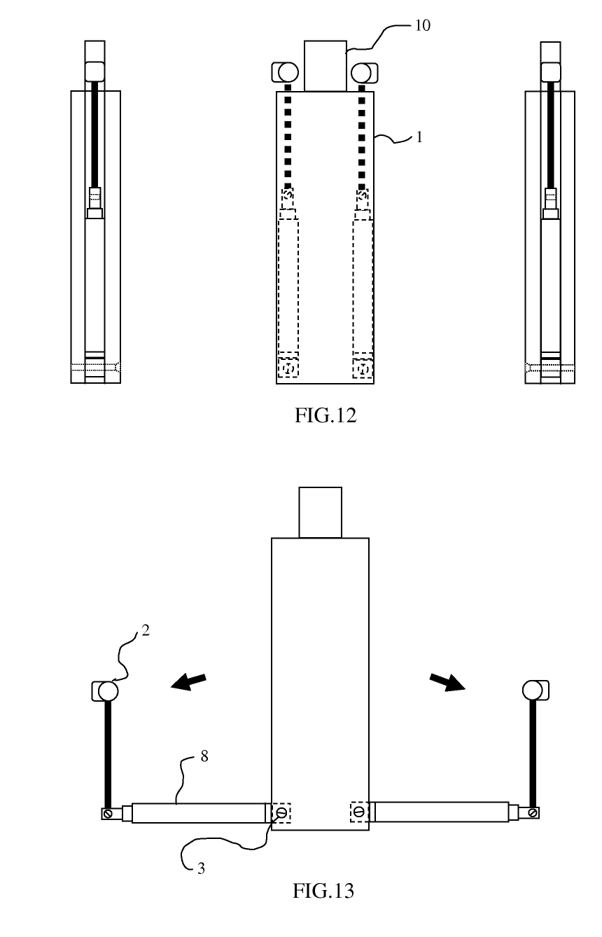

FIGS. 12, 13, 14, and 15 show a third variant of the invention for providing a universal accessory that is particularly well adapted to the constraints of a laptop computer;

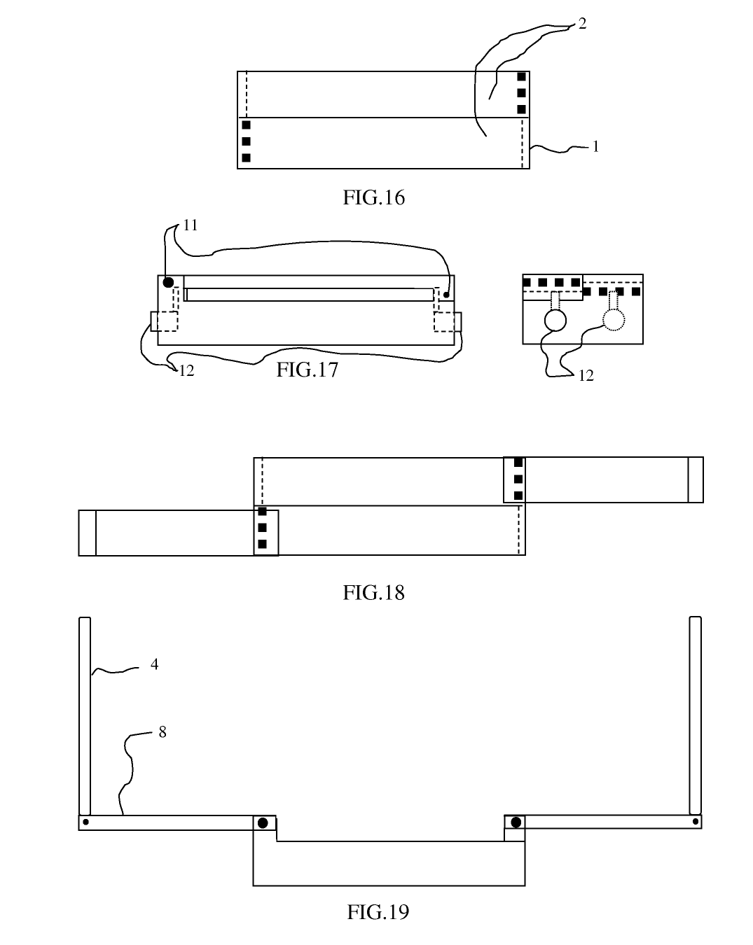

FIGS. 16, 17, 18, and 19 show a fourth variant of the invention;

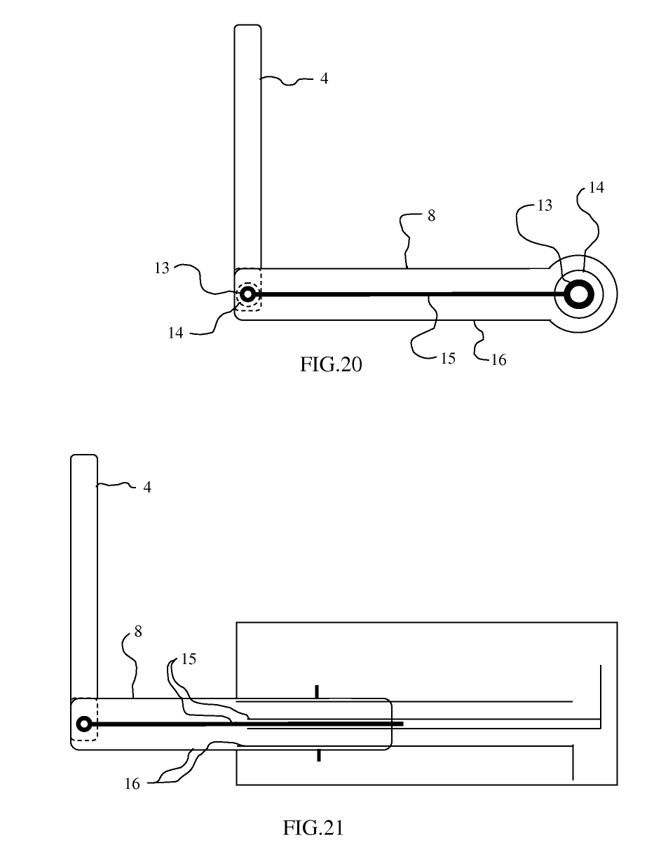

FIGS. 20 and 21 show embodiments of supports for an antenna radiating strand of the invention for forming a rigid coaxial connection having at least one degree of freedom;

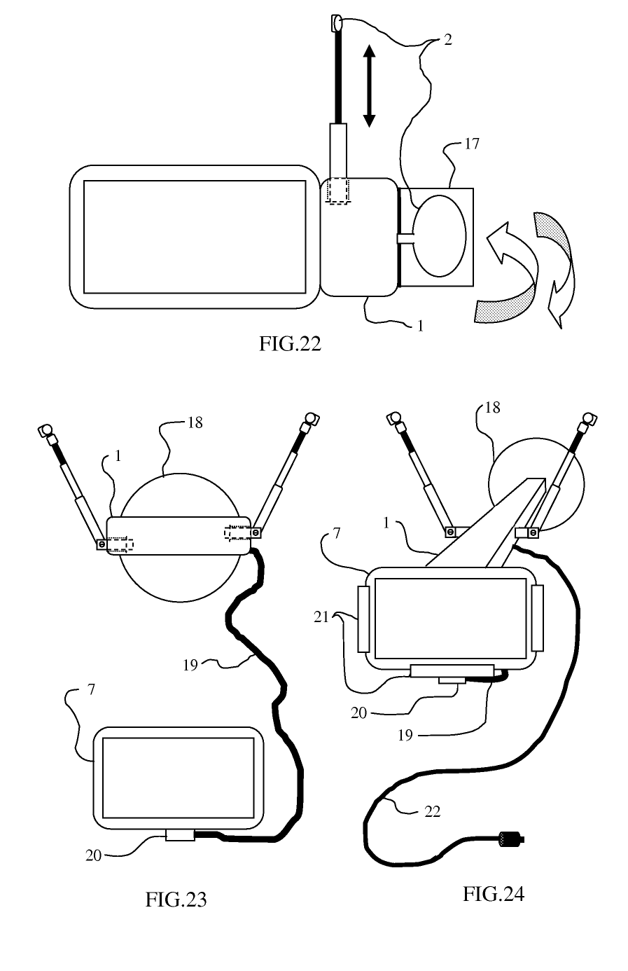

FIG. 22 shows a system of the invention implementing a diversity of antenna types;

FIG. 23 shows a system of the invention implementing a device that is mechanically separate from the appliance, the connection between them making use of a cable;

FIG. 24 shows a system of the invention in which said device also performs the role of supporting the appliance in a vehicle;

FIG. 25 shows a system of the invention in pedestrian use;

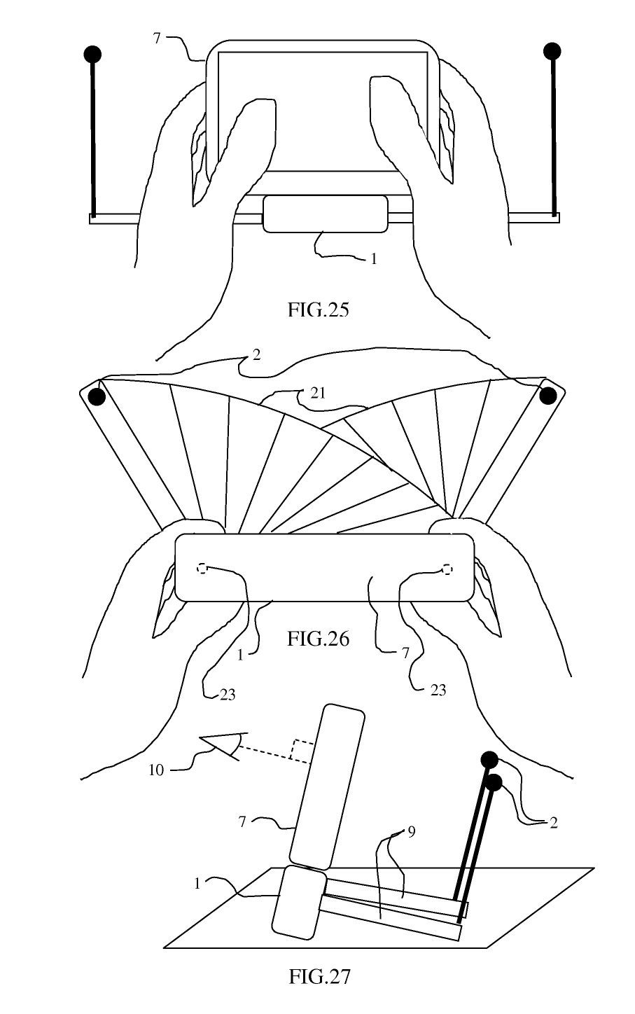

FIG. 26 shows a system of the invention with performance that is improved by the presence of a deployable ground plane; and

FIG. 27 shows a system of the invention in which the antenna supports also perform a function of supporting the system.

### DETAILED DESCRIPTION OF THE FIGURES

FIG. 1 shows a first variant of the invention that is simple and compact. The device of the invention is arranged to connect mechanically and electrically to a portable electronic appliance. Connections 3, 6 having one or more degrees of freedom enable the telescopic antennas 2 to be deployed on either side of the portable electronic appliance. The appliance remains within the ambit of the invention even if there is only a single strand 4 that is retractable into the housing of the device, given that a higher number of telescopic tubes 5 might be necessary in order to achieve a deployed antenna length that is optimized relative to the wavelengths used. Friction forces are used in all of the mechanical connections 3, 6 so as to ensure that the elements remain in the same positions relative to one another, e.g. in order to retain a position for the antennas that give good results.

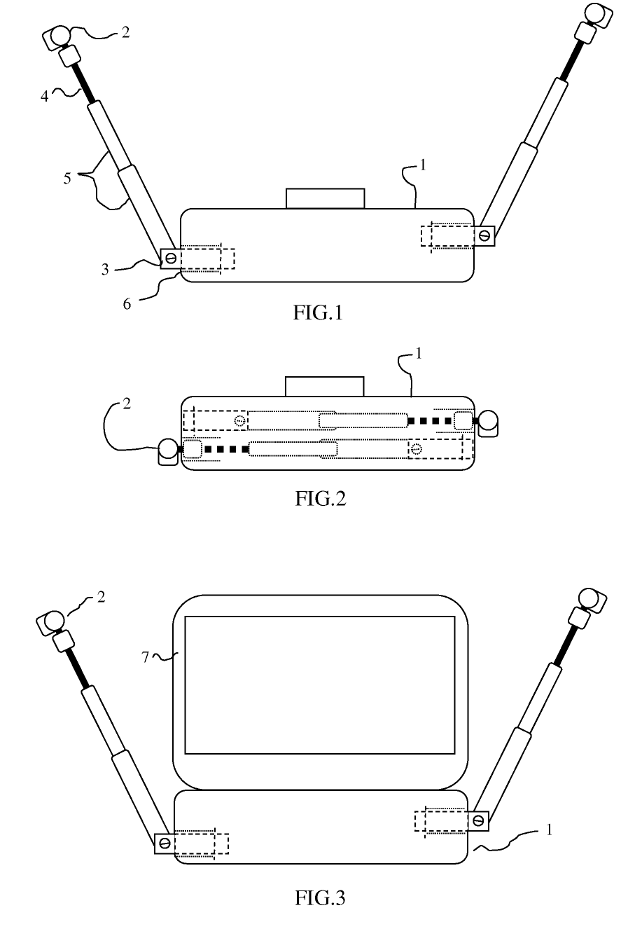

FIG. 2 shows the above embodiment variant of the invention in the folded position. The two telescopic antennas 2 are fully retracted into the housing of the device 1 of the invention, thus providing an accessory that is particularly compact for storage and transport.

FIG. 3 shows the above embodiment variant of the invention in its operational position with the antennas 2 deployed. The device 2 and the appliance 7 form a functional one-piece system of pleasing appearance that can be placed and held in the hand(s) without any cable getting in the user's way.

FIG. 4 shows another embodiment variant of the invention. It differs from the above-described variant in that the active strands 4 of the antennas 2 are arranged to be moved further apart from one another and further away collectively from the portable electronic appliance. This makes it possible respectively both to improve the gain provided by making use of diversity, and to improve the signal-to-noise ratio by moving the antennas away from the source of noise as constituted by the appliance. Advantageously, the antennas have a horizontal sheath 8 with its outer portion connected to ground and acting as a coaxial conductor for feeding the radiating strand. Electrical and mechanical implementation are simplified in that the power supply lines constituted in this way are substantially matched in the fully-deployed position of the sheaths. This position is the position that maximizes the performance of the system in operation.

FIG. 5 shows the above-described embodiment variant of the invention in the folded position.

FIG. 6 shows the system formed by a device 1 of the FIG. 4 embodiment variant fastened to a portable electronic appliance 7 in face view.

FIG. 7 shows the FIG. 6 system in side view. There can be seen the folded-out tongue 9 acting as a leg that holds the system as a whole in a position that is stable and advantageously inclined at an angle that is suitable for the viewing axis of the user 10 to be substantially perpendicular to the surface of the screen.

FIG. 8 shows an embodiment variant of the invention that enables the device 1 to be fitted to a portable electronic appliance 7 of the telephone type, having an orientation in use in which the long side of the housing and/or the screen is vertical.

FIG. 9 shows an embodiment variant of the invention that enables the device 1 to be fitted to a portable electronic appliance 7 of the music player type having an orientation in use in which the long side of the housing and/or the screen is vertical.

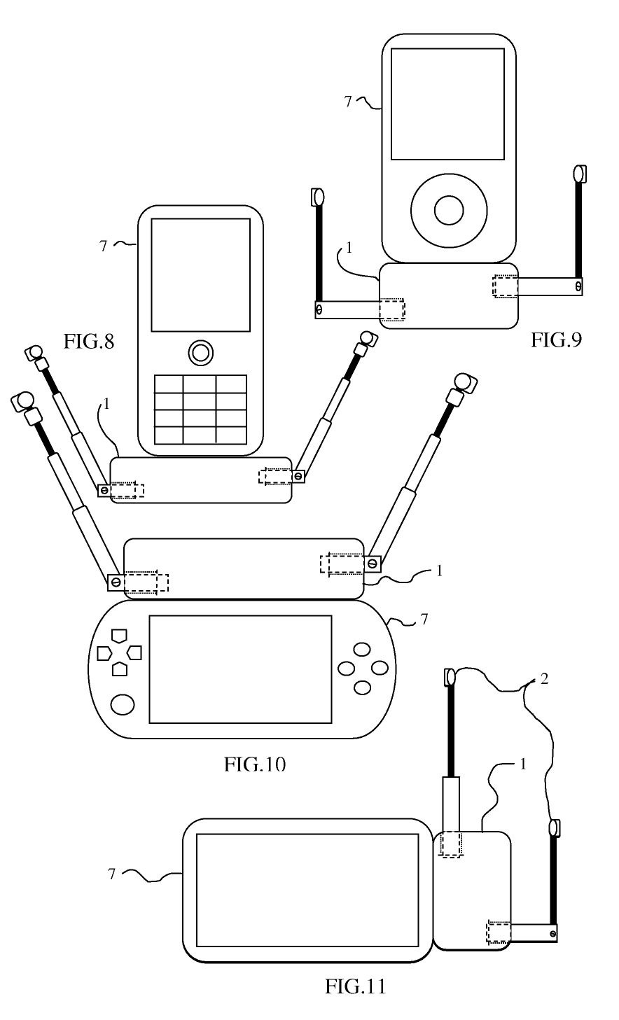

FIG. 10 shows an embodiment variant of the invention that enables the device 1 to be fitted to a portable electronic appliance 7 of the game console type having an orientation in use in which the long side of the housing and/or of the screen is horizontal. The device may be connected to the portable appliance via any one of its sides without going beyond the ambit of the invention. When one or more connectors are used simultaneously for making releasable mechanical and electrical connections between the device and the appliance, it is the position(s) of the connector(s) that determine(s) the positioning of the device of the invention relative to the appliance.

FIG. 11 shows an embodiment variant of the invention that enables the device 1 to be fitted to a portable electronic appliance 7 having an orientation in use in which the long side of the housing and/or the screen is horizontal. Advantageously, in this variant, each antenna 2 is deployable by implementing a different technique, for example a simple telescopic whip that is deployable vertically and another whip that can be oriented vertically or horizontally. It is advantageous to use a housing that includes metal surfaces acting as a ground plane.

FIG. 12 is a plan view and two side views showing an embodiment variant of the device 1 of the invention in the form of a USB stick folded in its storage position. This variant is particularly well adapted to forming a system with a laptop computer. The use of a connector 10 such as an “A” form USB connector serves to establish a connection between the device and the portable electronic appliance that is rigid and robust, both mechanically and electrically. The device may be disposed remotely by means of a standard male/female cable having appropriate connectors, in order to find a better operating position, should that be necessary.

FIG. 13 shows a FIG. 12 variant after the deployable support 8 for the antennas 2 have been turned relative to the housing about pivot axes 3. This movement enables the antennas to be folded out in the horizontal plane.

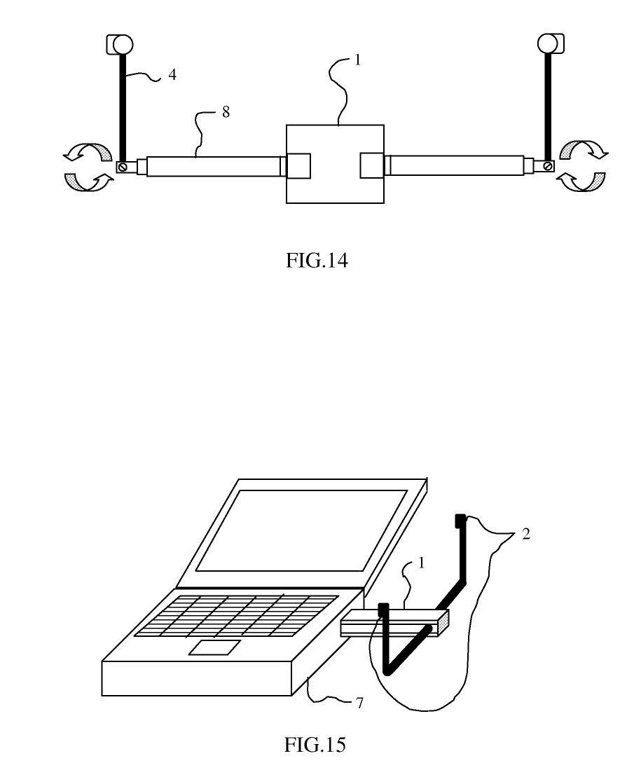

FIG. 14 shows the FIG. 13 variant after a second turning movement that enables the radiating portions 4 of the antennas to be placed at substantially 90° relative to the deployable support 8 of the antenna. The device 1 is thus in its main operational position.

FIG. 15 shows the variant of the system of the invention constituted by a laptop computer 7 and the FIG. 14 variant of the device 1 with its antennas 2 fully deployed.

FIG. 16 shows an embodiment variant of the device 1 of the invention in the form of a compact assembly in the folded position. In this non-limiting example, the device seen from above has two hinged antennas 2 mounted in opposite directions, with the width of each antenna being substantially half the width of the housing of the device.

FIG. 17 shows the FIG. 16 variant in face view and in side view. In the example shown, a mechanism including springs in each antenna hinge 11 and a locking and unlocking mechanism 12 for the folded position of each antenna enables the two antennas to be deployed automatically when the unlocking mechanism is actuated. Advantageously, a high-viscosity paste is located in each hinge 11 to brake the automatic deployment of the antennas under drive by the return forces of the springs.

FIG. 18 shows the variant of FIG. 16 with the antennas deployed, as seen from above.

FIG. 19 shows the variant of FIG. 16 with the antennas deployed, as seen in face view. There can be seen the operational position of the radiating strand 4 of each antenna together with a support 8 that is advantageously arranged to act as a ground plane.

FIG. 20 shows an embodiment of a coaxial connection of the invention for feeding the radiating strand 4 of a deployable antenna via a support 8 that is also deployable. By way of example, this variant corresponds to that shown in FIG. 16. Concentric conductive rings 13 and insulating rings 14 enable continuity of potential to be established in each hinge. The outer portions of the support 8 form the shielding 16 of the coaxial connection made in this way. The conductor 15 and the associated conductive rings 13 form the central core of the coaxial connection.

FIG. 21 shows another embodiment of a coaxial connection of the invention for feeding the radiating strand 4 of a deployable antenna via a support 8 that is likewise deployable. It differs from the above-described embodiments in that a degree of freedom in rotation is available for implementing a doubly-telescopic technique. A first set of telescopic tubes establishes continuity of the circuit 15 between the radiating portion 4 of the antenna and the electronics of the device. Another set of telescopic tubes surrounding the first but without their metal portions coming into contact forms the shielding 16 of the coaxial connection made in this way. The internal conductors 15 form the central core of the telescopic coaxial connection.

FIG. 22 shows an embodiment variant of the device 1 of the invention with a diversity of antenna types. In this example the same signal is picked up by two antennas 2 that are not only placed in different positions, but that also operate on two different principles: the whip principle and the magnetic loop principle. The loop is advantageously placed in a foldable flap 17 for storage purposes.

FIG. 23 shows an embodiment variant of the system of the invention in which the device 1 is connected to the portable electronic appliance by means of a cable 19 having a connector 20. The device 1 includes a fastener suction cup 18 adapted for fastening to the glass of a window in a building or a vehicle. Advantageously, the device 1 can be powered by the portable appliance 7 by conductors contained within the cable 19. It also has an input for an external power supply that is optional or necessary depending on how the power supply is designed, and possibly also powering the portable antenna via conductors contained within the cable 19.

FIG. 24 shows an embodiment variant of the system of the invention in which the device 1 is in the form of a bracket for fastening a portable electronic appliance 7 to a support such as a car windshield by means of a suction cup 18. The portable electronic appliance is mechanically fastened to the device by means of a support having jaws 21. The electrical connection between the device and the appliance is provided by means of a cable 19 fitted with a connector 20. The device 1 is powered by means of a dedicated cable 22 having an appropriate connector at its end such as a plug compatible with the cigar-lighter format.

Advantageously, the device 1 powers the portable appliance 7 via conductors included in the cable 19 so that the resulting system is not limited in battery life.

Even when the device 1 of the invention is not implemented for best reception of satellite geolocation signals, in particular so as to benefit from the additional gain provided by the antenna diversity, for example when the invention is implemented to receive digital TV in a vehicle, it is still advantageous to add a GPS and/or GALILEO reception subassembly to the functions of the device in that the marginal cost of this extra subassembly is small compared with the advantage of the function it provides. This optional additional reception subassembly can itself implement the invention or can make use of prior art techniques without that causing the system incorporating it to go beyond the ambit of the invention.

FIG. 25 shows an embodiment variant of the system of the invention in use in a pedestrian configuration. The device 1 is fastened by rigid means on the portable electronic appliance 7 so that the user can continue to use the portable appliance while moving.

FIG. 26 shows an embodiment variant of the system of the invention in which the device 1 fastened under the portable appliance 7 includes a deployable ground plane 21 for improving the performance of the antennas 2. In this non-limiting example, a mechanical technique close to that used for making fans or optical diaphragms is employed to create a continuous metal surface from a plurality of blades or sectors hinged about a conductive pin 23 that ensures that all of the individual elements are at the same potential and possibly connected to the electrical ground of the device. The area of the deployed ground planes may advantageously exceed the limits of the antenna supports.

FIG. 27 shows an embodiment variant of the system of the invention in which the deployable antennas 2 also act as a support 9 for holding the system as a whole in a position suitable for use, advantageously, in a position in which the screen of the appliance 7 is substantially perpendicular to the viewing access of the user 10. When the device 1 of the invention is connected to the portable electronic appliance by cable, the integrated support function remains advantageous for holding the device in a position that is more stable than is possible while it is standing on its bottom face, given that the bottom face is of small area because of the compactness desired for such an accessory.

Naturally, the invention is not limited to the examples described above, and numerous variations can be applied thereto, it being possible to select other combinations of characteristics and/or implementation techniques without going beyond the ambit of the invention. Furthermore, the technical standards and techniques that are mentioned are those that are in force at the time of filing the patent application. They may disappear or be replaced rapidly by others without that making the invention itself obsolete.

1-18. (canceled)

19. A device for enabling a portable electronic appliance to receive and/or transmit radio signals, the device being characterized in that it comprises at least one electronic subassembly, means for connecting the at least electronic subassembly of the device to the electronic appliance, at least two non-removable antennas used in diversity mode, that are secured to the device by implementing means that conserve the relative positions between said antennas and the device in the absence of external forces being applied between said elements.

20. A device according to claim 19, characterized in that it further comprises at least one separable rigid mechanical connection for fastening the device to the portable electronic appliance.

21. A device according to claim 19, characterized in that at least one non-removable antenna of the device is arranged to improve its performance by the presence of a ground plane and/or a conductor element.

22. A device according to claim 19, characterized in that said ground plane and/or conductor element is deployable.

23. A device according to claim 19, characterized in that at least one non-removable antenna of the device is of the wire type.

24. A device according to claim 19, characterized in that at least one non-removable antenna of the device is of the magnetic loop type.

25. A device according to claim 19, characterized in that at least one non-removable antenna of the device is of the plane type.

26. A device according to claim 19, characterized in that at least one non-removable antenna of the device is deployable.

27. A device according to claim 19, characterized in that at least one non-removable and deployable antenna of the device comprises a transmitter/receiver portion and a portion at ground potential.

28. A device according to claim 27, characterized in that the conductors for establishing electrical continuity between the deployable antenna and the reception and/or transmission electronics forms a connection of impedance that is substantially matched when the antenna is fully deployed.

29. A device according to claim 19, characterized in that at least one electronic subassembly of the device is powered by the portable electronic appliance to which it is connected.

30. A device according to claim 19, characterized in that it also powers the portable electronic appliance to which it is connected.

31. A device according to claim 19, characterized in that it further includes a support function.

32. A system for receiving and/or transmitting radio signals and for making use of them while mobile, the system comprising:
a device for enabling a portable electronic appliance to receive and/or transmit radio signals, the device being as defined in the preceding claims; and
a portable electronic appliance to which said device is connected.

33. An application of a system for receiving and/or transmitting radio signals and for making use of them while mobile according to claim 32, for receiving and playing back digital TV.

34. An application of a system for receiving and/or transmitting radio signals and for making use of them while mobile according to claim 32, for receiving and playing back a digital audio or video stream.

35. An application of the device as defined in claim 19, for receiving signals, transmitted by at least one satellite, on a portable electronic appliance.

36. An application of the device as defined in claim 19 for connecting a portable electronic appliance to a network.
